(19) United States
(12) Patent Application Publication
(10) Pub. No.: US 2009/0223133 A1
(43) Pub. Date: Sep. 10, 2009

(54) Self Locking Lifter Plate

(76) Inventors: Traian MIU, Oakville (CA); Douglass G. Broadhead, Brampton (CA); Thomas Mellary, Aurora (CA); Kurt Schatz, Newmarket (CA); James J. Ferri, Aurora (CA)

Correspondence Address: MAGNA INTERNATIONAL, INC., 337 MAGNA DRIVE, AURORA, ON, L4G-7K1, CA

(21) Appl. No.: 12/400,226

(22) Filed: Mar. 9, 2009

Related U.S. Application Data
(60) Provisional application No. 61/034,603, filed on Mar. 7, 2008.

(51) Int. Cl. E05F 11/38

(52) U.S. Cl. 49/375

(57) ABSTRACT

A clamping assembly for connecting a glass panel to a window regulator has a liner for gripping opposing sides of the glass panel and a holder, connectable to the window regulator, having a channel for seating the liner. At least one of the liner and the holder channel has sloping walls so that the gripping pressure of the holder and liner against the glass panel increases the deeper the liner sits in the holder channel. The liner includes an array of sloping teeth and the holder includes an array of sloping teeth, the liner teeth and holder teeth inter-engaging one another to form a ratcheting mechanism that enables the liner to travel in only one direction, deeper into holder.

This application claims the benefit of U.S. Provisional Application No. 61/034,603 filed Mar. 7, 2008 and entitled “Self Locking Lifter Plate”.

### FIELD OF THE INVENTION

The invention generally relates to the field of automotive window regulators, and more specifically to the art of connecting a glass panel to the operating structure of a window regulator.

### BACKGROUND OF THE INVENTION

In vehicles, the window regulator actuates a glass panel to and fro, typically between a closed position where the glass panel functions as a door window and a closed position where the panel is retracted at least partially within the cavity of a door structure. The glass panel is attached to the window regulator through one or more lifter plates. These lifter plates are generally attached to the glass panel through a secondary operation, where, for instance, a fastener is used to lock in a clamp or to attach to a feature bonded onto the glass gas panel. In some cases the glass panel may be attached without this secondary operation, but these designs typically utilize a pin feature that attaches to the glass through a hole that was previously drilled in the glass. It would be desirable to have a self-locking lifter plate that attaches to the glass panel without requiring a secondary operation or require a hole drilled through the glass panel.

### SUMMARY OF THE INVENTION

According to one aspect of the invention a clamping assembly is provided for connecting a glass panel to a window regulator. The assembly has a liner for gripping opposing sides of the glass panel. A holder, which is connectable to the window regulator, has a channel for seating the liner. At least one of the liner and the holder channel has sloping walls so that the gripping pressure of the holder and liner against the glass panel increases the deeper the liner sits in the holder channel. The liner includes an array of sloping teeth and the holder includes an array of sloping teeth, the liner teeth and holder teeth inter-engaging one another to form a ratcheting mechanism that enables the liner to travel in only one direction, deeper into holder.

In preferred embodiments a detent mechanism limits the travel of the liner into the holder until a specified force is applied to the liner in the direction of the holder channel. This force is achieved when the weight of the glass panel is brought to bear against the liner, which will occur only when the glass pane is fully seated in the liner. Thus, the liner will not move into the clamping portion of the assembly until the glass panel is completely seated in the liner, thereby ensuring the proper engagement between the glass panel and the liner.

### BRIEF DESCRIPTION OF THE DRAWINGS

The invention will now be described, by way of example only, with reference to the attached Figures, wherein:

FIG. 1 is perspective view of a self-locking lifter plate assembly according to a first embodiment of the invention;

FIG. 2 is side view of the assembly shown in FIG. 1;

FIG. 3 is an isolated perspective view of a liner employed in the first embodiment;

FIG. 4 is an isolated perspective view of a holder employed in the first embodiment;

FIG. 5 is perspective view of a self-locking lifter plate assembly according to a second embodiment of the invention;

FIG. 6 is a cross-sectional view of the assembly shown in FIG. 5, taken along line VI-VI therein;

FIG. 7 is an isolated perspective view of a liner employed in the second embodiment;

FIG. 8 is an isolated perspective view of a holder employed in the second embodiment;

FIG. 9 is an isolated perspective view of a locking clip employed in the second embodiment; and

FIG. 10 is a partially assembled view of the second embodiment.

### DETAILED DESCRIPTION OF THE INVENTION

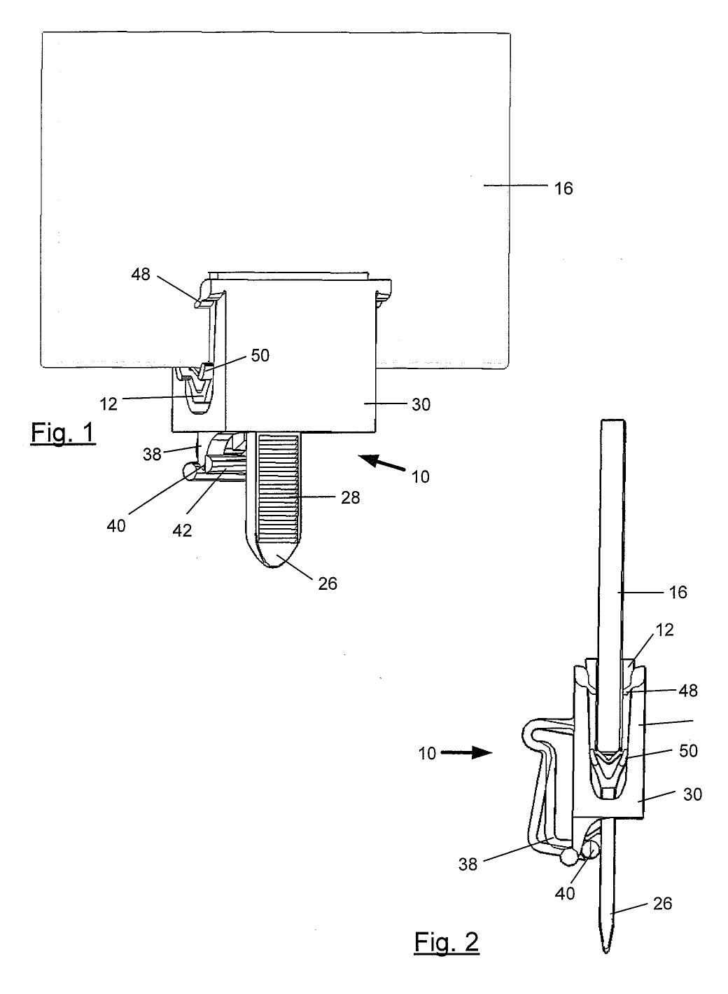

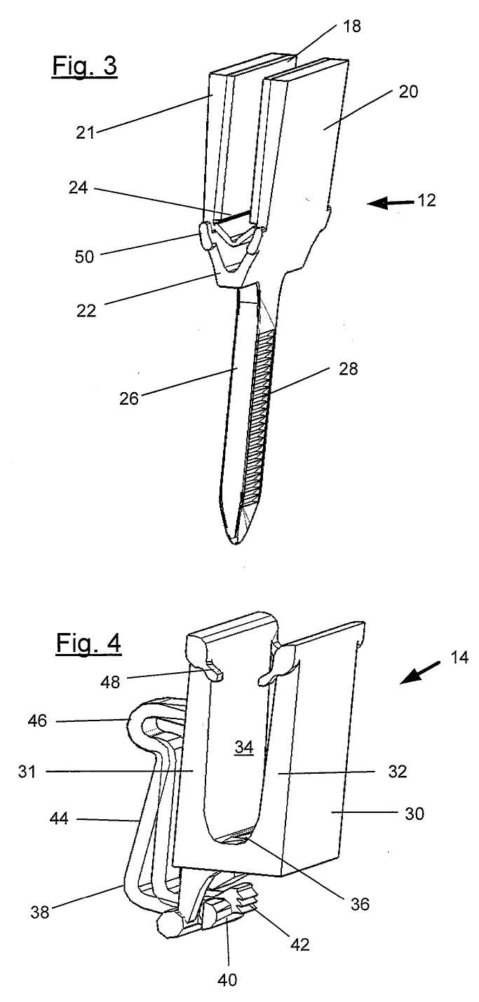

A first embodiment of a self-locking lifter plate assembly 10 is shown in FIGS. 1-4. Referring to these drawings, the assembly 10 includes two main parts, a liner 12 (shown in isolation in FIG. 3) that contacts a glass panel 16 and a holder 14 (shown in isolation in FIG. 4) that retains the liner 12. The liner 12 is seated in the holder 14 in such a manner so as to generate a self-adjusting clamping force on the glass panel 16. To ensure the clamping force is maintained the liner 12 is mechanically limited in its direction of travel and allowed to travel only in a direction in which the clamping force increases.

More particularly, the liner 12 is preferably manufactured from a relatively rigid plastic material with a much softer over-molded wrapper portion 18 (such as gripping foam) that directly warps around and contacts a portion of the glass panel 16. The liner includes a U-shaped upper portion having opposing walls 20, 21 that flank the wrapper portion 18. The walls 20, 21 are connected by an adjoining base portion 22 of the liner and a living hinge 24 is provided between the walls 20, 21 and the adjoining base portion 22 so as to allow the walls 20,21 to flex inwards and outwards relative to one another.

A shaft 26 extends from the base portion 22. The shaft 26 has at least one planar face and preferably two opposing planar faces each featuring an array of upwardly sloping teeth 28 formed therein.

The holder 14 is also preferably molded from a relatively rigid plastic and includes a seat 30 for retaining the U-shaped upper portion of the liner 12. The seat 30 has two opposing walls 31, 32 which, in side view, are sloped so as to provide a wedge or V-shaped channel 34 in the seat 30. Thus, the deeper the liner 12 is inserted into the holder 14 the greater the clamping force on the glass panel 16.

The base of the seat 30 also includes an aperture 36 for passage of the liner shaft 26 therethrough. The liner shaft 26 interacts with a clip 38 that depends from one of the walls 31, 32 of the holder 14. The clip 38 has a protrusion 40 that features an array of teeth 42 that are sloped opposite to the teeth 28 present in the planar face of shaft 26. The clip 38 and its protrusion 40 are disposed to engage and interact with the shaft 26 such that the shaft teeth 28 and protrusion teeth 42 provide a ratcheting mechanism, enabling the liner 12 to only travel in only one direction-deeper into the seat 30. The ratcheting mechanism allows some deflection so that the liner teeth 28 and the holder teeth 42 can pass over each other, but only in a single direction, in the opposite direction the teeth are designed to lock. The clip 38, by virtue of its shape (having elongate depending arm 44 and curved connecting portion 46), is however somewhat resiliently flexible and may be manually urged away from its locking position to release the liner shaft so that the glass panel may be pulled out of the assembly 10 for vehicle servicing and the like.

In operation, the liner 12 is initially only partially seated in the holder 14, so that the ratcheting mechanism is able to prevent the components from separating from one another. In this initial installation position, a mechanical detent provided by flexibly resilient holder tangs 48, which project inwardly from the walls 31, 32 into channel 34, and liner side projections 50 limits the travel of the liner 12 into the holder 14 until a specified threshold force is applied. This force is achieved when the weight of the glass panel 16 is brought to bear against the liner, which will occur only when the glass pane 16 is fully seated in the liner 12. Thus, the liner will not move into the clamping portion of the assembly until the glass panel is completely seated in the liner, thereby ensuring the proper engagement between the glass panel and the liner. When the window regulator (not shown in its entirety) is actuated to drive the glass pane 16 into its closed position, the window regulator will drive the holder 14 against the held-in-position glass pane 16, thus fully seating the liner 12 and glass panel 16 in the holder 14. Any subsequent slack between the liner 12 and the glass panel that may later occur due to settling of the components or wear and tear will be taken up in due course as the window regulator is routinely operated and the liner 12 is forced deeper into the holder 14.

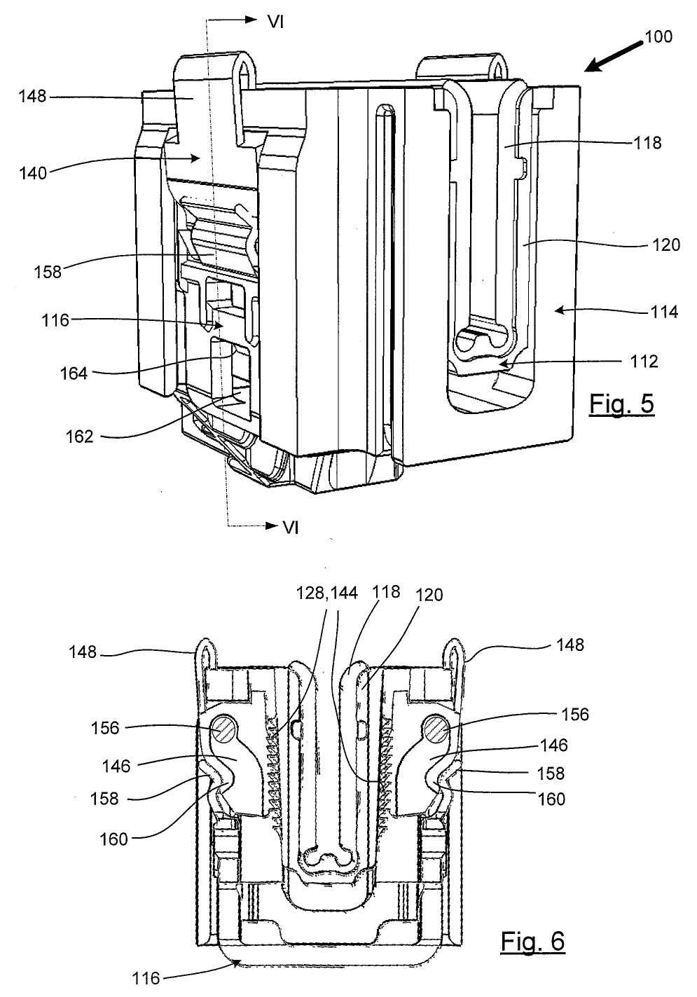

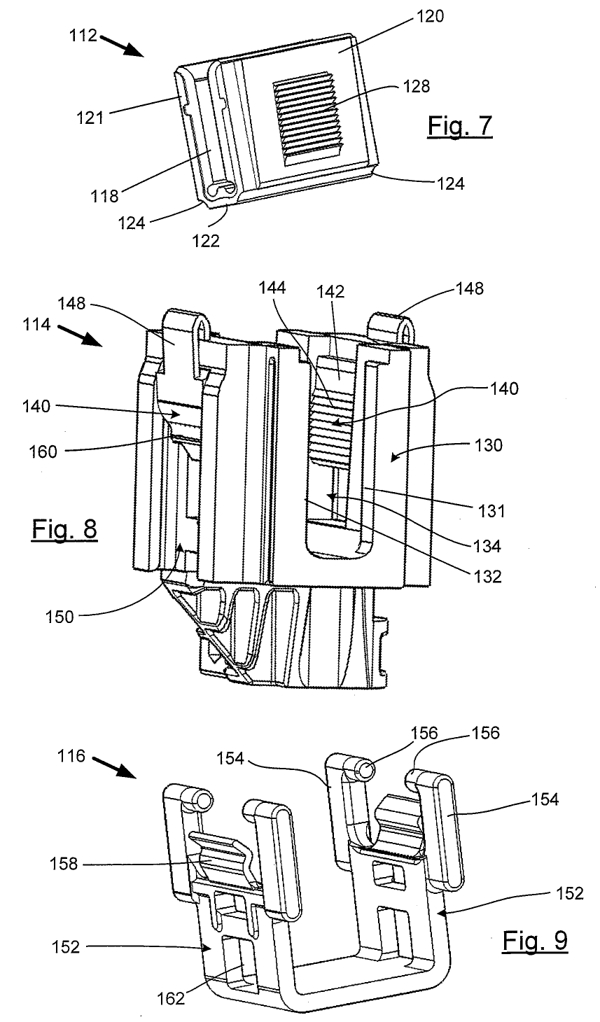

FIGS. 5 and 6 show a second embodiment of a self-locking lifter plate assembly 100 in perspective and cross-sectional views, respectively. Referring to these assembly drawings and FIGS. 7, 8 and 9 which various components in isolation, the assembly 100 includes three main components, a U-shaped liner 112 (FIG. 7) that contacts the glass panel, a holder 114 (FIG. 8) that seats the liner 112, and a locking clip 116 (FIG. 9).

The liner 112 is preferably manufactured from a relatively rigid plastic material and has a much softer wrapper portion 118 (such as gripping foam) that directly wraps around and contacts a portion of the glass panel. The U-shaped liner 112 has opposing walls 120, 121 that flank the wrapper portion 118. The walls 120, 121 are connected by an adjoining base portion 122 of the liner and living hinges 124 are provided between the walls 120, 121 and the adjoining base portion 122 so as to allow the walls 120, 121 to flex inwards and outwards relative to one another.

The outer face of each of the holder walls 120,121 feature an array of upwardly sloping teeth 128 formed therein. The liner 112 and its teeth 128 form a first portion of a ratchet mechanism.

The holder 114 is also preferably molded from a relatively rigid plastic and includes a seat 130 for retaining the U-shaped liner 112. The seat 130 has two opposing walls 131, 132 which, in side view, are sloped so as to provide a wedge or V-shaped channel 134 in the seat 130. Thus, the deeper the liner 112 is inserted into the holder 114 the greater the clamping force on the glass panel.

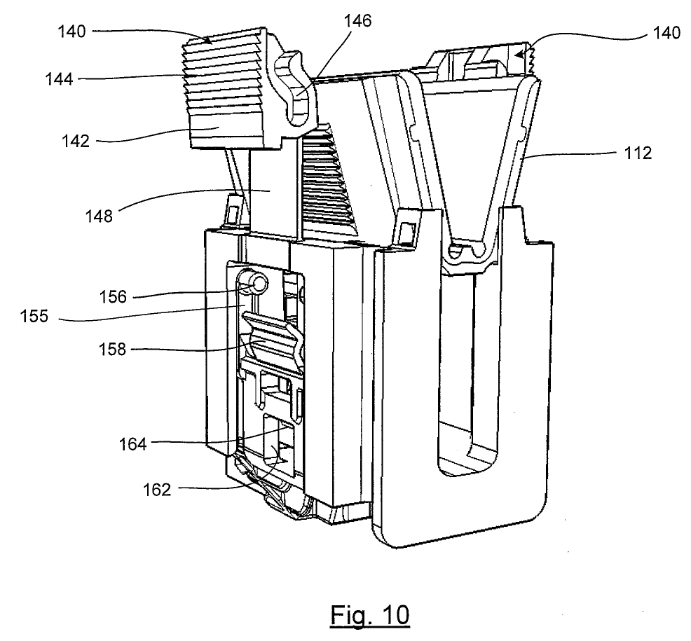

Referring additionally to a partially assembled view of the assembly 100 in FIG. 10, the holder 114 provides a second part of the ratchet mechanism. In the second embodiment the holder 114 includes two pads 140. Each pad 140 has a planar face 142 featuring a plurality of teeth 144. On the sides of each pad, a serpentine groove 146 is formed in the body of each pad 140. The pads 140 are connected to the holder 114 via flexible straps 148 that are integrally formed with the holder 114 and project from the top edges thereof.

In assembly, the pads 140 are folded into apertures 150 (seen best in FIG. 8) located in the sidewalls of the holder 114 so that the teeth 144 face inwardly into the holder to mate with the liner teeth 128.

The locking clip 116 has two opposing wings 152. Each wing 152 has two spaced apart arms 154 that feature transversely orientated pin-like terminations (pins) 156. A flexibly resilient serpentine tab 158 is disposed between the two arms 154. More particularly, the wings 152 of the locking clip 116 slide into the apertures 150 of the holder 114 such that the serpentine tab 158 overlies a correspondingly curved tab 160 (seen best in FIG. 6) disposed on the pad 140. In particular, the arms 154 slide into grooves 155 located at the side peripheries of the holder apertures 150 such that each pin 156 extends out of corresponding groove 155 (seen best in FIG. 10). The pins 156 (FIG. 6) install into the serpentine grooves 146 of the pads 140, preventing the pads 140 from lifting out yet enabling the pads 140 to rock or pivot about the pins 152. In addition, the clip serpentine tabs 158 provide resistance to the pads pivoting in a direction away from the channel 134.

For locking the clip 116 into the holder, the clip 116 includes apertures 162 disposed in each wing 152. The resilient wings 152 must be forced over sloping locking tabs 164 (seen best in FIG. 5) provided in the holder 114 until the locking tabs 164 sit in the apertures. Thereafter, the clip 116 will be releasably locked against the holder 114.

In operation, the pads 140 are folded into the apertures 150 and the locking clip 116 is locked into the holder 114. The liner 112 is initially only partially seated in the holder 114 such that the ratcheting mechanism is able to prevent the components from separating from one another. In this initial installation position, a mechanical detent is provided by the flexibly resilient locking clip tabs 158 and the corresponding holder tabs 160, which tend to push the pads 140 inwardly into channel 134, thus limiting the travel of the liner 112 into the holder 114 until a specified force is applied. This force is achieved when the weight of the glass panel is brought to bear against the liner 112, which will occur only when the glass pane is fully seated in the liner 112. Thus, the liner 112 will not move into the clamping portion of the assembly 100 until the glass panel is completely seated in the liner 112, thereby ensuring the proper engagement between the glass panel and the liner 112. When the window regulator (not shown in its entirety) is actuated to drive the glass pane into its closed position, the window regulator will drive the holder 114 against the held-in-position glass pane, thus fully seating the liner 112 and glass panel in the holder 114. The ratcheting mechanism allows some deflection so that the liner teeth 128 and the holder pad teeth 144 can pass over each other, but only in a single direction, in the opposite direction the teeth are designed to lock, and deeper into the holder 114, thus increasing the clamping force of the assembly 100. Any subsequent slack between the liner and the glass panel that may later occur due to settling of the components or wear and tear will be taken up in due course as the window regulator is routinely operated and the liner 1 12 is forced deeper into the holder 114.

It will be appreciated that although the above described embodiments have described the liner as having a U-shaped form and the holder as having a V shaped form for increasing the clamping forces on the glass panel as the liner is embedded deeper into the holder, the liner can instead be provided with sloping outer walls and the holder having a U-shaped form to achieve the same result. Similarly, other alterations and modifications may be effected to the above-described embodiments, which are intended to be examples of the invention only, without departing from the spirit of the invention.

1. A clamping assembly for connecting a glass panel to a window regulator, comprising:
a liner for gripping opposing sides of the glass panel;
a holder connectable to the window regulator, the holder having a channel for seating the liner, wherein at least one of the liner and the holder channel has sloping walls so that the gripping pressure of the holder and liner against the glass panel increases the deeper the liner sits in the holder channel;
wherein the liner includes an array of sloping teeth and the holder includes an array of sloping teeth, the liner teeth and holder teeth inter-engaging one another to form a ratcheting mechanism that enables the liner to travel in only one direction, deeper into holder.

2. A clamping assembly according to claim 1, including a detent mechanism which limits the travel of the liner into the holder until a specified force is applied to the liner in the direction of the holder channel.

3. A clamping assembly according to claim 2, wherein the liner has two opposing walls capable of flexing relative to one another.

4. A clamping assembly according to claim 3, including a wrapper disposed inward of the liner walls for directly contacting the glass panel, the wrapper being manufactured from a softer material than the liner walls.

5. A clamping assembly according to claim 2, wherein:
a shaft extends from the liner, the shaft incorporating said liner teeth thereon;
the holder has an aperture permitting the liner shaft to extend therethrough; and
the holder has a flexibly resilient arm that incorporates said holder teeth thereon, the teeth of the flexibly resilient arm engaging the teeth of the liner shaft to provide said ratcheting mechanism.

6. A clamping assembly according to claim 3, wherein the detent mechanism comprises a tab depending from the liner walls and a resiliently deformable tang depending from holder, the liner tab and holder tang being disposed to engage one another at a particular point in the travel of the liner into the holder channel.

7. A clamping assembly according to claim 3, wherein:
each of the opposing liner walls incorporates said liner teeth on a face of the wall opposite the glass panel;
the holder has opposing sidewalls forming said channel;
each holder sidewall has an aperture therein, the teeth of each liner wall being at least partially disposed in each corresponding holder aperture; and
a pad is moveably connected to each holder sidewall, each pad incorporating said holder teeth thereon, each pad being disposed in the corresponding holder aperture such that the pad teeth engage the liner teeth to provide said ratcheting mechanism.

8. A clamping assembly according to claim 7, including a locking clip releasably connected to the holder for maintaining the engagement of the holder pad teeth against the liner wall teeth.

9. A clamping assembly according to claim 8, wherein the pads are connected to the holder via flexible straps.

10. A clamping assembly according to claim 8, wherein:
each pad has opposing sidewalls, each pad sidewall having a serpentine groove therein;
the locking clip has two opposing wings, each wing having two opposing arms, each arm having a pin termination at a direction transverse to the arm;
the holder includes grooves at the side peripheries of the holder apertures; and
in assembly, the locking clip arms are seated in the holder grooves and the pin terminations are seated in the pad grooves, thereby enabling each pad to pivot in the holder aperture.

11. A clamping assembly according to claim 9, wherein each locking clip wing includes a resiliently deformable tab which, in assembly, is disposed in the corresponding holder aperture and abuts the pad, thereby maintaining the engagement of the holder pad teeth against the liner wall teeth.

12. A clamping assembly according to claim 8, including a first part of a detent mechanism disposed on the holder and a second part of the detent mechanism disposed on the locking clip for releasably locking the clip against the, holder.
